(19) United States
(12) Patent Application Publication
(10) Pub. No.: US 2023/0318146 A1
(43) Pub. Date: Oct. 5, 2023

(54) NONAQUEOUS ELECTROLYTE SECONDARY BATTERY SEPARATOR

(71) Applicant: Sumitomo Chemical Company, Limited, Tokyo (JP)

(72) Inventors: Takahiro MATSUO, Niihama-shi (JP); Kensaku HORIE, Niihama-Shi (JP); Atsushi NAKAZAWA, Niihama-shi (JP); Ryutaro SHIBA, Niihama-shi (JP)

(21) Appl. No.: 18/127,148

(22) Filed: Mar. 28, 2023

(30) Foreign Application Priority Data
Mar. 30, 2022 (JP) 2022-056535

(51) Int. Cl. H01M 50/489; H01M 50/417; H01M 50/449; H01M 50/491; H01M 50/423

(52) U.S. Cl. CPC H01M 50/489; H01M 50/417; H01M 50/449; H01M 50/491; H01M 50/423

(57) ABSTRACT

Provided is a nonaqueous electrolyte secondary battery separator which is excellent in withstand voltage property, in conformability to external force, and in liquid retention property. The nonaqueous electrolyte secondary battery separator includes: a porous film containing a polyolefin-based resin as a main component; and a porous layer containing a resin and formed on one surface or both surfaces of the porous film, the porous layer having an air permeability of not more than 500 sec/100 mL in terms of Gurley values and having an open area ratio of not more than 2%.

This Nonprovisional application claims priority under 35 U.S.C. §119 on Patent Application No. 2022-056535 filed in Japan on Mar. 30, 2022, the entire contents of which are hereby incorporated by reference.

### TECHNICAL FIELD

The present invention relates to a separator for a nonaqueous electrolyte secondary battery (hereinafter also referred to as a “nonaqueous electrolyte secondary battery separator” or simply as a “separator”).

### BACKGROUND ART

Nonaqueous electrolyte secondary batteries, particularly lithium-ion secondary batteries, have a high energy density, and are therefore in wide use as batteries for devices such as personal computers, mobile telephones, and portable information terminals. Such nonaqueous electrolyte secondary batteries have recently been developed as on-vehicle batteries.

Recently, in accordance with expansion of applications of the nonaqueous electrolyte secondary batteries, a separator is required to be heat-resistant in order to further improve the safety of a battery. Examples of the separator having an improved heat-resistance include a nonaqueous electrolyte secondary battery separator including a porous film that includes: a porous base material; and a porous layer which is formed on at least one surface of the porous base material and which contains inorganic particles and a heat-resistant resin (Patent Literature 1).

### CITATION LIST

### Patent Literature

### Patent Literature 1

Pamphlet of International Publication No. WO 2018/155288

### SUMMARY OF INVENTION

### Technical Problem

However, the above-described conventional separator has room for improvement in withstand voltage property.

It is an object of an embodiment of the present invention to improve a withstand voltage property of a nonaqueous electrolyte secondary battery separator.

### Solution to Problem

The present inventors found, as a result of diligent studies, that the foregoing problem could be solved by a separator including a porous film and a porous layer which is formed on one surface or both surfaces of the porous film, which has a specific air permeability, and a surface of which has an open area ratio of not more than a specific value. As a result, the present inventors arrived at the present invention.

The present invention includes aspects described in <1> to <6> below.
<1> A nonaqueous electrolyte secondary battery separator including:
a porous film containing a polyolefin-based resin as a main component; and
a porous layer formed on one surface or both surfaces of the porous film,
the porous layer containing a resin,
the porous layer having an air permeability of not more than 500 sec/100 mL in terms of Gurley values, and
the porous layer having an open area ratio of not more than 2%,
where the open area ratio is calculated from a value that has been obtained by measuring a surface of the porous layer with use of a scanning electron microscope and binarizing an image of the surface with use of image processing software.
<2> The nonaqueous electrolyte secondary battery separator according to <1>, wherein the porous layer has a porosity of not less than 40% and not more than 80%.
<3> The nonaqueous electrolyte secondary battery separator according to <1> or <2>, wherein the resin is at least one selected from the group consisting of a polyolefin, a (meth)acrylate-based resin, a fluorine-containing resin, a polyamide-based resin, a polyester-based resin, and a water-soluble polymer.
<4> The nonaqueous electrolyte secondary battery separator according to <3>, wherein the polyamide-based resin is an aramid resin.
<5> A member for a nonaqueous electrolyte secondary battery (hereinafter, also referred to simply as “nonaqueous electrolyte secondary battery member”), the member comprising:
a positive electrode;
the nonaqueous electrolyte secondary battery separator according to any one of <1> to <4>; and
a negative electrode,
the positive electrode, the nonaqueous electrolyte secondary battery separator, and the negative electrode being disposed in this order.
<6> A nonaqueous electrolyte secondary battery comprising the nonaqueous electrolyte secondary battery separator according to any one of <1> to <4>.

### Advantageous Effects of Invention

An embodiment of the present invention can advantageously provide a nonaqueous electrolyte secondary battery separator having an excellent withstand voltage property.

### BRIEF DESCRIPTION OF DRAWINGS

FIG. 1 is a view schematically illustrating a shape of an uneven surface of a cylindrical electrode probe of a withstand voltage tester that was used for measurement of the withstand voltage property in Examples of the present application.

### DESCRIPTION OF EMBODIMENTS

The following description will discuss embodiments of the present invention. Note, however, that the present invention is not limited to the embodiments. The present invention is not limited to arrangements described below, but may be altered in various ways by a skilled person within the scope of the claims. The present invention also encompasses, in its technical scope, any embodiment derived by combining technical means disclosed in differing embodiments. Note that a numerical expression “A to B” herein means “not less than A and not more than B” unless otherwise stated.

### Embodiment 1: Nonaqueous Electrolyte Secondary Battery Separator

A nonaqueous electrolyte secondary battery separator in accordance with an embodiment of the present invention includes: a porous film containing a polyolefin-based resin as a main component; and a porous layer formed on one surface or both surfaces of the porous film, the porous layer containing a resin and having an air permeability of not more than 500 sec/100 mL in terms of Gurley values and an open area ratio of not more than 2%. Here, the open area ratio is calculated from a value that has been obtained by measuring a surface of the porous layer with use of a scanning electron microscope and binarizing an image of the surface with use of image processing software.

### Porous Film

The porous film in an embodiment of the present invention contains a polyolefin-based resin as a main component. Here, the expression “contain a polyolefin-based resin as a main component” means that the polyolefin-based resin in the porous film accounts for not less than 50% by weight, preferably not less than 90% by weight, and more preferably not less than 95% by weight with respect to all constituent materials of the porous film.

The porous film has therein many pores connected to one another, so that a gas and a liquid can pass through the porous film from one side to the other.

The porous film has a thickness of preferably 4 μm to 40 μm, and more preferably 5 μm to 20 μm. The porous film having a thickness of not less than 4 μm makes it possible to sufficiently prevent an internal short circuit of the battery. Meanwhile, the porous film having a thickness of not more than 40 μm makes it possible to prevent an increase in size of the nonaqueous electrolyte secondary battery.

The polyolefin-based resin preferably contains a high molecular weight component having a weight-average molecular weight of 5×10⁵ to 15×10⁶. In particular, the polyolefin-based resin more preferably contains a high molecular weight component having a weight-average molecular weight of not less than 1,000,000 because such a high molecular weight component improves the strength of a resultant porous film and the strength of a separator including the resultant porous film

The polyolefin-based resin is not limited to a particular one. Examples of the polyolefin-based resin include thermoplastic resins such as homopolymers and copolymers each obtained by (co)polymerizing a monomer(s) such as ethylene, propylene, 1-butene, 4-methyl-1-pentene, and/or 1-hexene. Examples of such homopolymers include polyethylene, polypropylene, and polybutene. Examples of such copolymers include an ethylene-propylene copolymer.

Among these examples, polyethylene is preferable because use of polyethylene makes it possible to prevent (shut down) a flow of an excessively large electric current into a separator at a lower temperature. Examples of the polyethylene include low-density polyethylene, high-density polyethylene, linear polyethylene (ethylene-a-olefin copolymer), and ultra-high molecular weight polyethylene having a weight-average molecular weight of not less than 1,000,000. Among these examples, the ultra-high molecular weight polyethylene is more preferable.

A weight per unit area of the porous film can be set as appropriate in consideration of the strength, thickness, weight, and handleability of the porous film. Note, however, that the weight per unit area of the porous film is preferably 4 g/m² to 20 g/m², more preferably 4 g/m² to 12 g/m², and still more preferably 5 g/m² to 10 g/m², so as to allow the nonaqueous electrolyte secondary battery to have a higher weight energy density and a higher volume energy density.

The porous film has an air permeability of preferably 30 sec/100 mL to 500 sec/100 mL, and more preferably 50 sec/100 mL to 300 sec/100 mL in terms of Gurley values in order to allow the porous film to achieve sufficient ion permeability.

The porous film has a porosity of preferably 20% by volume to 80% by volume, and more preferably 30% by volume to 75% by volume, so as to (i) retain a larger amount of electrolyte and (ii) obtain a function of reliably preventing a flow of an excessively large electric current at a lower temperature. Further, in order to achieve sufficient ion permeability and prevent particles from entering a positive electrode and/or a negative electrode, the porous film has pores each having a pore size of preferably not more than 0.3 μm, and more preferably not more than 0.14 μm.

### Method for Producing Porous Film

A method for producing the porous film is not limited to a particular one. For example, the porous film can be produced by a method as follows. First, polyolefin-based resin is kneaded together with a pore forming agent such as an inorganic bulking agent or a plasticizer, and optionally with another agent(s) such as an antioxidant. After kneading, the kneaded substances are extruded so as to produce a polyolefin resin composition in sheet form. The pore forming agent is then removed from the polyolefin resin composition in sheet form with use of a suitable solvent. After the pore forming agent is removed, the polyolefin resin composition is stretched so that a polyolefin porous film is obtained.

Examples of the inorganic bulking agent include inorganic fillers; one specific example is calcium carbonate. Examples of the plasticizer include a low molecular weight hydrocarbon such as liquid paraffin.

### Porous Layer

The porous layer in an embodiment of the present invention has an air permeability of not more than 500 sec/100 mL in terms of Gurley values and has an open area ratio of not more than 2%.

The expression “have an air permeability of not more than 500 sec/100 mL in terms of Gurley values” means that the porous layer has, inside of the porous layer, a specific amount of voids (holes) which have a certain size and which serve as a path that allows gas such as air to pass through the path. The open area ratio is a parameter indicative of a void ratio that is measured, by a method described later, in one of faces of the porous layer which is located opposite to the other face in contact with the porous film, that is, in a surface of the porous layer. The expression “have an open area ratio of not more than 2%” means that in the surface of the porous layer, there are very few voids to be measured by the method described later. Having the air permeability and the open area ratio within the above-described respective ranges does not mean that the porous layer has no holes but means that the porous layer has, at the surface thereof, a dense pore structure formed so as to include pores whose sizes are so small that the open area ratio can be measured only to be not more than 2% by the method described later. The dense pore structure is less likely to collapse even when an excessive voltage is applied. Therefore, including such a porous layer, the separator in accordance with an embodiment of the present invention advantageously have an excellent withstand voltage property.

The open area ratio is calculated with use of a value that has been obtained by measuring a surface of the porous layer with use of a scanning electron microscope (SEM) and binarizing an image of the surface with use of image processing software. Specifically, the open area ratio can be measured by the method described in Examples. Note that the “surface” of the porous layer refers to an area which can be observed when one of faces of the porous layer which is located opposite to the other face in contact with the porous film is observed under a general condition with use of the SEM.

In order to improve the withstand voltage property, the porous layer has an air permeability of preferably not more than 500 sec/100 mL in terms of Gurley values and an open area ratio of preferably not more than 1% and more preferably not more than 0.05%. Further, the open area ratio is not less than 0% and preferably not less than 0.01%.

In addition, when the porous layer has an air permeability of not more than 500 sec/100 mL in terms of Gurley values, the porous layer is easily deformed by external force and thus easily absorbs the external force. The separator in accordance with an embodiment of the present invention includes such a porous layer and thus has an excellent conformability to electrode expansion and shrinkage which occur when charge and discharge are repeated in a nonaqueous electrolyte secondary battery. Note that the “inside” means a portion that is in the porous layer and that does not correspond to the “surface” described above.

In view of the conformability, the air permeability is preferably not more than 300 sec/100 mL, and more preferably not more than 200 sec/100 mL in terms of Gurley values. Further, the air permeability is preferably not less than 50 sec/100 mL, and more preferably not less than 70 sec/100 mL in terms of Gurley values.

The surface of the porous layer has a dense pore structure. Meanwhile, the porous layer has an internal structure which has voids of a specific size. The porous layer can thus retain a nonaqueous electrolyte in the voids. In addition, the dense pore structure of the surface of the porous layer makes the nonaqueous electrolyte less likely to leak. Therefore, since the separator in accordance with an embodiment of the present invention includes such a porous layer, the separator has an excellent liquid retention property.

### Resin

In an embodiment of the present invention, the porous layer contains a resin. If the porous layer contains a filler which will be described later, the resin can serve as a binder resin to (i) bind filler particles to each other (ii) bind the filler and a positive electrode or negative electrode together, or (iii) bind the filler and the porous film together.

In an embodiment of the present invention, it is preferable that the resin be insoluble in the electrolyte of the battery, and when the battery is in normal use, the resin is electrochemically stable. In addition, the resin is preferably a heat-resistant resin.

The resin is not limited to a particular one. Examples of the resin include polyolefins; (meth)acrylate-based resins; fluorine-containing resins; polyamide-based resins; polyimide-based resins; polyester-based resins; rubbers; resins with a melting point or glass transition temperature of not lower than 180° C.; water-soluble polymers; polycarbonate; polyacetal; and polyether ether ketone. It is possible to contain one of the resins or a mixture of two or more of the resins.

Of the examples of the resin, the polyolefin-based resins, the polyester-based resins, the acrylate-based resins, the fluorine-containing resins, the polyamide-based resins, and the water-soluble polymers are preferable. Examples of the polyamide-based resins include aromatic polyamides. Of the aromatic polyamides, a wholly aromatic polyamide (aramid resins) is preferable. Of the polyester-based resins, polyarylates and liquid crystal polyesters are preferable. Of the fluorine-containing resins, polyvinylidene fluoride-based resins are preferable. Examples of the water-soluble polymers include polyvinyl alcohol, polyethylene glycol, cellulose ether, sodium alginate, polyacrylic acid, polyacrylamide, and polymethacrylic acid.

Specific examples of the aramid resin include poly(paraphenylene terephthalamide), poly(methaphenylene isophthalamide), poly(parabenzamide), poly(metabenzamide), poly(4,4′-benzanilide terephthalamide), poly(paraphenylene-4,4′-biphenylene dicarboxylic acid amide), poly(methaphenylene-4,4′-biphenylene dicarboxylic acid amide), poly(paraphenylene-2,6-naphthalene dicarboxylic acid amide), poly(methaphenylene-2,6-naphthalene dicarboxylic acid amide), poly(2-chloroparaphenylene terephthalamide), a paraphenylene terephthalamide/2,6-dichloroparaphenylene terephthalamide copolymer, a methaphenylene terephthalamide/2,6-dichloroparaphenylene terephthalamide copolymer, poly(4,4′-diphenylsulfonyl terephthalamide), and a paraphenylene terephthalamide/4,4′-diphenylsulfonyl terephthalamide copolymer. Among these examples, poly(paraphenylene terephthalamide) is more preferable.

Further, it is possible to use, as the polyamide-based resin, a resin having a structure in which some of amide bonds are replaced with bonds other than the amide bonds, that is, a polyamide-based resin including amide bonds and bonds other than the amide bonds. The bonds other than the amide bonds are not particularly limited. Examples of such a bond include a sulfonyl bond, an alkenyl bond (for example, C1-C5 alkenyl bond), an ether bond, an ester bond, an imide bond, a ketone bond, and a sulfide bond. It is possible to use one kind of such bonds other than the amide bonds or two or more of such bonds other than the amide bonds.

In view of heat-resistance of the porous layer, in the polyamide-based resin, the amide bonds account for preferably 45% to 85%, and more preferably 55% to 75% of the total number of the amide bonds and the bonds other than the amide bonds.

In order to allow the porous layer to have a high-voltage withstand property, the bonds other than the amide bonds preferably include bonds each having an electron-withdrawing property which is stronger than those of the amide bonds. Examples of such a bond having an electron-withdrawing property which is stronger than those of the amide bonds include a sulfonyl bond and an ester bond.

In the polyamide-based resin, the bonds each having an electron-withdrawing property which is stronger than those of the amide bonds account for preferably 15% to 35%, and more preferably 25% to 35% of the total number of the amide bonds and the bonds other than the amide bonds. The above-described rates are preferable in order to improve the high-voltage resistance of the porous layer.

Examples of the resin including the amide bonds and the bonds other than the amide bonds include: polyamide and polyamide imide; a copolymer of polyamide or polyamide imide and a polymer including at least one bond selected from the group consisting of a sulfonyl bond, an ether bond, and an ester bond. The copolymer may be a block copolymer or may be a random copolymer.

The polyamide of which the resin is made is preferably an aromatic polyamide. Examples of the aromatic polyamide include a wholly aromatic polyamide (aramid resin) and a semi-aromatic polyamide. As the aromatic polyamide, the wholly aromatic polyamide is preferable. Examples of the aromatic polyamide include a para-aramid and a meta-aramid.

The polyamide imide of which the resin is made is preferably an aromatic polyamide imide. Examples of the aromatic polyamide imide include a wholly aromatic polyamide imide and a semi-aromatic polyamide imide. As the wholly aromatic polyamide imide, the wholly aromatic polyamide imide is preferable.

Examples of the polymer including at least one bond selected from the group consisting of a sulfonyl bond, an ether bond, and an ester bond include polysulfone, polyether, and polyester.

### Method for Producing Resin

A method for producing the resin is not limited to a particular one, and a conventionally and publicly known method can be employed as appropriate.

For example, if the resin is an aromatic polyamide, the resin can be produced by reacting an aromatic diamine and an aromatic acyl in an organic solvent.

Examples of the aromatic diamine include oxydianiline, paraphenylenediamine, methaphenylenediamine, benzophenone diamine, 4,4′-methylenedianiline, 4,4′-diaminobenzophenone, 4,4′-diaminodiphenyl sulfone, 2,6′-naphthalene diamine, 2-chloroparaphenylenediamine, and 2,6-dichloroparaphenylenediamine. Among these examples, the paraphenylenediamine is preferable. Each of these aromatic diamines may be used solely. Alternatively, two or more of the aromatic diamines may be used in combination.

Examples of the aromatic acyl include an aromatic acid dihalide. Examples of the aromatic acid dihalide include terephthalic acid dichloride, isophthalic acid dichloride, pyromellitic acid dichloride, 1,5-naphthylene dicarboxylic acid dichloride, 3,3′-biphenylene dicarboxylic acid dichloride, 3,3′-benzophenone dicarboxylic acid dichloride, and 3,3′-diphenyl sulfone dicarboxylic acid dichloride. Each of these aromatic acyls may be used solely. Alternatively, two or more of the aromatic acyls may be used in combination.

The aromatic polyamide can be obtained, for example, by reacting (polymerizing) the aromatic diamine and the aromatic acyl at a reaction temperature of −20° C. to 50° C. in an organic solvent in which a halide of an alkali metal or of an alkali earth metal has been l dissolved. A molar ratio of the aromatic diamine and the aromatic acyl (aromatic diamine/aromatic acyl) is preferably 1.0 to 1.1. A concentration of the halide dissolved in the organic solvent is preferably 2% by weight to 10% by weight.

Examples of the halide include: a chloride of an alkali metal, such as lithium chloride, sodium chloride, and potassium chloride; a chloride of an alkali earth metal, such as magnesium chloride, and calcium chloride. Among these examples, the calcium chloride is preferable. Each of these chlorides may be used solely. Alternatively, two or more of these chlorides may be used in combination.

Satisfaction of conditions (1) to (3) described below makes it possible to obtain an aromatic copolymer that achieves a polymerization degree enough to form a porous layer that has more excellent heat resistance.
(1) The molar ratio of the aromatic diamine and the aromatic acyl (aromatic diamine/aromatic acyl) is adjusted so as to fall within the above-described range.
(2) The reaction temperature is adjusted so as to fall within the above-described range.
(3) The concentration of the chloride dissolved in the organic solvent is adjusted so as to fall within the above-described range.

A method for adding the aromatic diamine and the aromatic acyl to the organic solvent is not limited to a particular one. For example, in the organic solvent in which a chloride of an alkali metal or of an alkali earth metal has been dissolved, the aromatic acyl may be dissolved, and then the aromatic diamine may be added. Alternatively, in the organic solvent in which a chloride of an alkali metal or of an alkali earth metal has been dissolved, the aromatic diamine may be dissolved, and then the aromatic acyl may be added.

The aromatic diamine and/or the aromatic acyl may be added as a solid in powder form, or may be added as a melt that is maintained at a temperature equal to or higher than a melting point. Alternatively, the aromatic diamine and/or the aromatic acyl may be added as a solution in which the aromatic diamine and/or the aromatic acyl is dissolved in an organic solvent, or may be added as a solution in which the aromatic diamine and/or the aromatic acyl is dissolved in the organic solvent in which a chloride of an alkali metal or of an alkali earth metal has been dissolved in advance.

The aromatic diamine and the aromatic acyl may be added to an organic solvent at a time or separately.

Examples of the organic solvent include aprotic polar solvents such as lower alcohols (such as methyl alcohol, ethyl alcohol, and isopropyl alcohol), hexane, acetone, toluene, xylene, N-methyl-2-pyrrolidone, N,N-dimethylacetamide, and N,N-dimethylformamide. Among these examples, the N-methyl-2-pyrrolidone is preferable. Each of these organic solvents may be used solely. Alternatively, two or more these organic solvents may be used in combination.

The organic solvent may contain water. If the organic solvent contains water, it is possible to control a viscosity of a polymerized composition and a molecular weight.

It is preferable to control, to 1% by weight to 50% by weight, an amount of the organic solvent used relative to the total amount of the aromatic diamine and the aromatic acyl, that is, a concentration of the aromatic polyamide at the point of time when the reaction in the organic solvent is finished.

### Filler

In an embodiment of the present invention, the porous layer may contain a filler. The content of the filler with respect to the total weight of the porous layer is preferably not less than 20% by weight and not more than 80% by weight, and more preferably not less than 30% by weight and not more than 70% by weight.

In an embodiment of the present invention, the filler is not particularly limited in material. The filler may be composed of a single filler which is made of one kind of a material, or may be composed of two or more kinds of fillers which are formed by respective different materials.

The filler may be an inorganic filler or an organic filler. Examples of the inorganic filler include fillers made of inorganic matters such as calcium carbonate, talc, clay, kaolin, silica, hydrotalcite, diatomaceous earth, magnesium carbonate, barium carbonate, calcium sulfate, magnesium sulfate, barium sulfate, aluminum hydroxide, boehmite, magnesium hydroxide, calcium oxide, magnesium oxide, titanium oxide, titanium nitride, alumina (aluminum oxide), aluminum nitride, mica, zeolite, and glass. Among these examples, the inorganic filler is preferably a filler made of an inorganic oxide such as silica, calcium oxide, magnesium oxide, titanium oxide, alumina, mica, zeolite, aluminum hydroxide, or boehmite, more preferably a filler made of calcium oxide, magnesium oxide, or alumina, and still more preferably a filler made of alumina. Examples of the organic filler include a filler made of a resin.

The filler is not particularly limited in shape. The filler may have, for example, a spherical shape, an elliptical shape, a plate shape, a bar shape, or an indefinite irregular shape. Among these examples, the filler preferably has a spherical shape.

The filler has an average particle diameter of preferably not less than 0.01 μm and not more than 10 μm, and more preferably not less than 0.02 μm and not more than 5 μm.

### Physical Properties of Porous Layer

The porous layer has a thickness of preferably 0.5 μm to 15 μm, and more preferably 1 μm to 10 μm. The thickness falling within the above-described range is suitable, for example, for (i) preventing an internal short circuit due to, for example, breakage of a nonaqueous electrolyte secondary battery, (ii) for retaining an electrolyte in a porous layer, and (iii) for preventing a deterioration in rate characteristic or cycle characteristic.

A weight per unit area of the porous layer can be set as appropriate in consideration of the strength, thickness, weight, and handleability of the porous layer. The weight per unit area is preferably 0.5 g/m² to 20 g/m² per porous layer, and more preferably 0.5 g/m² to 10 g/m². When the weight per unit area of the porous film falls within the above-described numerical range, it is possible to allow the nonaqueous electrolyte secondary battery to have a high weight energy density and a high volume energy density.

The porous layer has a porosity of preferably not less than 40% and not more than 80%, and more preferably not less than 50% and not more than 70%. When the porosity of the porous layer falls within the above-described range, it is possible to allow a separator and a nonaqueous electrolyte secondary battery including the separator to achieve sufficient ion permeability.

Pores included in the porous layer each have a pore size of preferably not more than 1.0 μm, and more preferably not more than 0.5 μm. When the pores of the porous layer each have a pore size falling within above-described range, it is possible to allow a separator and a nonaqueous electrolyte secondary battery including the separator to achieve sufficient ion permeability.

The porous layer may contain a component other than the resin and the filler. Examples of the other component include a surfactant and a wax. The content of the other component is preferably 0% by weight to 10% by weight with respect to the total weight of the porous layer.

### Method for Producing Porous Layer

A method for producing the porous layer can be, for example, a method in which (i) a coating solution is prepared by dissolving the resin in a solvent, (ii) a coating layer is formed by applying the coating solution onto a base material, and then (iii) the solvent is removed from the coating layer, so that the porous layer is formed. Examples of the base material include the porous film. Further, if the porous layer contains the filler, it is possible to use, as the coating solution, a coating solution that is prepared by not only dissolving the resin in a solvent but also dispersing the filler.

The solvent (dispersion medium) can be any solvent which can uniformly and stably dissolve the resin without an adverse effect to the base material such as the porous film. If the filler is contained, the solvent can be any solvent which, in addition, can uniformly and stably disperse the filler. Specific examples of the solvent include: water; lower alcohols such as methyl alcohol, ethyl alcohol, n-propyl alcohol, isopropyl alcohol, and t-butyl alcohol; acetone; toluene; xylene; hexane; N-methylpyrrolidone (NMP); N,N-dimethylacetamide; and N,N-dimethylformamide. Each of the solvents may be used solely. Alternatively, two or more of the solvents may be used in combination.

The coating solution may be prepared by any method, provided that the coating solution satisfies conditions, such as the resin solid content (resin concentration) and, if the filler is contained, the amount of the filler, which are necessary to produce a desired porous layer. Specific examples of the method for preparing the coating solution include a mechanical stirring method, an ultrasonic dispersion method, a high-pressure dispersion method, and a media dispersion method. When the coating solution contains the filler, the filler may be dispersed in the solvent with use of, for example, a conventionally and publicly known dispersing machine such as a three-one motor. Note that the coating solution can contain, in addition to the resin and the filler, an additive(s) such as a disperser, a plasticizer, a surfactant, and/or a pH adjustor, provided that the additive does not prevent the object of the present invention from being attained.

A method for applying the coating solution onto the base material is not limited to a particular one. The method can be, for example, (i) a sequential formation method in which a porous layer is formed on one surface of a base material and then another porous layer is formed on the other surface of the base material, or (ii) a simultaneous formation method in which porous layers are formed simultaneously on both surfaces of the base material.

The coating solution can be applied onto the base material by any method which can achieve a necessary weight per unit area and a necessary coating area. The method for applying the coating solution can be, for example, a conventionally and publicly known method, such as a gravure coater method.

A method for forming the porous layer is not limited to a particular one. Examples of the method include (a) and (b) below.
(a) A method in which the coating layer is deposited by immersing the coating layer into a deposition solution, and then is washed with water and dried to remove the solvent, so that the porous layer is formed (hereinafter, referred to as “immersion method”).
(b) A method in which the coating layer is deposited by drying the base material on which the coating layer is formed and removing the solvent, so that the porous layer is formed (hereinafter, referred to as “dry method”).

In the immersion method, the coating layer can be immersed in the deposition solution by any method. Both the coating layer and the base material may be immersed in the deposition solution. Alternatively, the coating layer alone may be immersed in the deposition solution.

It is possible to employ, as the deposition solution, a mixture of a solvent in which the resin is insoluble and an organic solvent in which the resin is soluble. It is possible to regulate a speed at which the resin is deposited, by controlling, in the deposition solution, a mixing ratio of the solvent in which the resin is insoluble and the organic solvent. Specifically, when the mixing ratio of the organic solvent in the deposition solution is small, the speed at which the resin is deposited is increased.

When the deposition speed of the resin is fast, the resin is deposited as fine particles each having a small particle diameter. While the coating layer is immersed in the deposition solution, the fine particles which have been deposited penetrate into the coating layer, and inside the coating layer, the fine particles flow in the deposition solution which has permeated the coating layer. Here, while flowing, some of the fine particles agglomerate into particles (secondary particles) each having a large particle diameter. The secondary particles each have a large particle diameter and easily accumulate. The secondary particles thus accumulate on the porous film, and form an internal structure of the porous layer. Therefore, the internal structure thus formed by the porous layer has a specific amount of voids which are formed by the secondary particles and each of which has a certain size.

At the end of the immersion, the coating layer contains the secondary particles which have been accumulated and the fine particles which are flowing inside the coating layer without agglomerating. The coating layer is washed with water and dried, so that the fine particles accumulate without agglomerating on the internal structure which is of the porous layer and which is made of the secondary particles that have accumulated. The fine particles thus form the surface of the porous layer. Therefore, a resultant surface of the porous layer has a dense pore structure formed by the fine particles. As described above, when the mixing ratio of the organic solvent is set to be appropriately small, the deposition speed of the resin is caused to be appropriately fast. This makes it possible to produce the porous layer in an embodiment of the present invention.

The solvent in which the resin is insoluble is not limited to a particular one. Examples of such a solvent include water. The organic solvent is not limited to a particular one. Examples of the organic solvent include NMP. The suitable range of the mixing ratio of the organic solvent in the deposition solution may vary depending on kinds of the resin, the solvent in which the resin is insoluble, and the organic solvent. For example, if (i) the resin is an aramid resin, (ii) the solvent in which the resin is insoluble is water, and (iii) the organic solvent is NMP, then the porous layer in an embodiment of the present invention can be suitably produced by controlling the mixing ratio of the NMP in the deposition solution (in which water and NMP are mixed) to 0% to 20%

In the dry method, the deposition speed of the resin can be regulated by controlling drying conditions, such as a drying temperature. Specifically, under severer drying conditions, such as a higher drying temperature, the deposition speed of the resin becomes faster. Also in the dry method, as in the case of the immersion method, the resin to form the internal structure of the porous layer is first deposited, and the resin to form the surface of the porous layer is deposited at the end.

Therefore, the porous layer in an embodiment of the present invention can be produced, for example, by the following method: in the dry method, the coating layer is dried under loose conditions, such as a low drying temperature, and then is dried under severe conditions, such as a high drying temperature.

Such a method leads to a resultant porous layer that has an internal structure having a specific amount of voids, each of which has a certain size and which are formed by the particles that each have a large particle diameter and that are deposited by drying under loose conditions. Meanwhile, the surface of the resultant porous layer is configured to have a dense pore structure which is formed by fine particles that each have a small particle diameter and that are deposited by drying under severe conditions. As a result, the porous layer in an embodiment of the present invention can be suitably produced.

When the porous layer contains the filler, the filler may push the layers of the resin and spread the space between the layers of the resin in the porous layer. As a result, voids may be formed in the porous layer. In that case, an aspect of the voids in the porous layer can be controlled also by controlling the particle diameter of the filler and the content of the filler. When the particle diameter of the filler and the content of the filler fall within the ranges that are described to be preferable in [Filler] above, it is possible to control the size of the voids and the number of the voids (porosity) to respective suitable ranges. As a result, it is possible to suitably produce the porous layer in an embodiment of the present invention.

### Embodiment 3: Nonaqueous electrolyte Secondary Battery Member, and Embodiment 4: Nonaqueous Electrolyte Secondary Battery

A nonaqueous electrolyte secondary battery member in accordance with an embodiment of the present invention includes a positive electrode, the separator in accordance with an embodiment of the present invention, and a negative electrode, the positive electrode, the separator, and the negative electrode being disposed in this order. A nonaqueous electrolyte secondary battery in accordance with an embodiment of the present invention includes the separator in accordance with an embodiment of the present invention.

The nonaqueous electrolyte secondary battery member in accordance with an embodiment of the present invention including the separator can advantageously have an excellent withstand voltage property in a nonaqueous electrolyte secondary battery. The nonaqueous electrolyte secondary battery in accordance with an embodiment of the present invention including the separator can advantageously have an excellent withstand voltage property.

The nonaqueous electrolyte secondary battery can be produced by a conventionally and publicly known method. As one example, first, a nonaqueous electrolyte secondary battery member is formed by providing a positive electrode, the separator, and a negative electrode in this order. Here, the porous layer in the separator is present between the porous film and the positive electrode and/or between the porous film and the negative electrode. Subsequently, the nonaqueous electrolyte secondary battery member is put into a container, which serves as a housing for the nonaqueous electrolyte secondary battery. The container is filled with a nonaqueous electrolyte, and then is hermetically sealed while pressure is reduced in the container. This can produce the nonaqueous electrolyte secondary battery.

### Positive Electrode

The positive electrode employed in an embodiment of the present invention is not limited to a particular one, provided that the positive electrode is one that is generally used as a positive electrode of a nonaqueous electrolyte secondary battery. Examples of the positive electrode include a positive electrode sheet having a structure in which an active material layer, containing a positive electrode active material and a binding agent, is formed on a positive electrode current collector. The active material layer may further contain an electrically conductive agent.

Examples of the positive electrode active material include materials each capable of being doped with and dedoped of metal ions such as lithium ions or sodium ions. Specific examples of the materials include lithium complex oxides each containing at least one selected from the group consisting of transition metals such as V, Mn, Fe, Co, and Ni.

Examples of the electrically conductive agent include at least one selected from the group consisting of, for example, carbonaceous materials such as natural graphite, artificial graphite, cokes, carbon black, pyrolytic carbons, carbon fiber, and a fired product of an organic polymer compound.

Examples of the binding agent include: fluorine-based resins such as polyvinylidene fluoride (PVDF); acrylic resin; and styrene butadiene rubber.

Examples of the positive electrode current collector include electric conductors such as Al, Ni, and stainless steel.

Examples of a method for producing the positive electrode sheet include a method in which the positive electrode active material, the electrically conductive agent, and the binding agent are pressure-molded on the positive electrode current collector.

### Negative Electrode

The negative electrode employed in an embodiment of the present invention is not limited to a particular one, provided that the negative electrode is one that is generally used as a negative electrode of a nonaqueous electrolyte secondary battery. Examples of the negative electrode include a negative electrode sheet having a structure in which an active material layer, containing a negative electrode active material and a binding agent, is formed on a negative electrode current collector. The active material layer may further contain an electrically conductive agent.

Examples of the negative electrode active material include materials each capable of being doped with and dedoped of metal ions such as lithium ions or sodium ions. Examples of the materials include carbonaceous materials, such as natural graphite.

Examples of the negative electrode current collector include Cu, Ni, and stainless steel.

Examples of a method for producing the negative electrode sheet include a method in which the negative electrode active material is pressure-molded on the negative electrode current collector.

### Nonaqueous Electrolyte

A nonaqueous electrolyte in an embodiment of the present invention is not limited to a particular one, provided that the nonaqueous electrolyte is one that is generally used for a nonaqueous electrolyte secondary battery. The nonaqueous electrolyte can be, for example, a nonaqueous electrolyte containing an organic solvent and a lithium salt dissolved therein. Examples of the lithium salt include at least one selected from the group consisting of LiClO₄, LiPF₆, LiAsF₆, LiSbF₆, LiBF₄, LiCF₃SO₃, LiN(CF₃SO₂)₂, LiC(CF₃SO₂)₃, Li₂B₁₀Cl₁₀, lower aliphatic carboxylic acid lithium salt, LiAlCl₄ and the like.

Examples of the organic solvent contained in the nonaqueous electrolyte include at least one selected from the group consisting of, for example, carbonates, ethers, esters, nitriles, amides, carbamates, sulfur-containing compounds, and fluorine-containing organic solvents each obtained by introducing a fluorine group into any of these organic solvents.

### EXAMPLES

The present invention will be described below in more detail with reference to Examples and Comparative Examples. Note, however, that the present invention is not limited to such Examples.

### Method for Measuring Physical Properties

In Examples and Comparative Examples, physical properties were measured by respective methods described below.

### Thickness

The thickness of a separator was measured with use of a high-precision digital length measuring machine (VL-50) manufactured by Mitutoyo Corporation.

### Weight per Unit Area of Porous Layer

A sample was cut out from a separator so as to have a square shape having a side of 8 cm, and the weight W₁ (g) of the sample was measured. Further, a sample had been cut out in advance from a porous film used in each of Examples and Comparative Examples described later to have a square shape having a side of 8 cm, and the weight W₂ (g) of the sample was measured.

With use of the values of W₁ and W₂ thus measured, the weight per unit area [g/m^{2]} of a porous layer was calculated based on the following Formula (1).

Weight per unit area of porous layer=(W₁−W₂)/(0.08×0.08) . . . Formula (1)

### Air Permeability of Porous Layer

The air permeabilities of the separator and the porous film in terms of Gurley values were measured in conformity to JIS P8117. With use of the air permeabilities thus measured of the separator and the porous film, the air permeability of the porous layer in terms of Gurley values was calculated based on the following Formula (2).

Air permeability of porous layer (sec/100 mL)=(air permeability of separator)−(air permeability of porous film) . . . Formula (2)

### Porosity of Porous Layer

Constituent materials of the porous layer are denoted as a, b, c, . . . , respectively. Respective mass compositions of the constituent materials are denoted as Wa, Wb, We . . ., Wn (g/cm³). Respective real densities of the constituent materials are denoted as da, db, dc . . . , do (g/cm³). The thickness of the porous layer is denoted as t (cm). With use of these parameters, the porosity ε [%] of the porous layer was calculated based on the following Formula (3).

Porosity ε of porous layer=[1−{(Wa/da+Wb/db+We/dc+ . . . +Wn/dn)/t}]×100 . . . Formula (3)

As the real density of a filler, employed was the density disclosed in product information on the filler used. As the real density of a resin, employed was the density disclosed in Non-Patent Literature 1 (Takashi Noma. “Aramidosenni no Tokutyou to Youto (Characteristics and Applications of Aramid)”, Special topic “Gouseisenni no Kaihatsu Doukou (Move in Development of Synthetic Fibers”). Senni to Kougyou (Fibers and Industries). p. 242).

### Porosity of Separator

Constituent materials of the separator are denoted as a, b, c . . . , respectively. Respective mass compositions of the constituent materials are denoted as Wa, Wb, We . . . , Wn (g/cm3). Respective real densities of the constituent materials are denoted as da, db, dc . . . , dn (g/cm3). The thickness of the separator is denoted as t (cm). With use of these parameters, the porosity ε [%] of the separator was calculated based on the following Formula (4).

Porosity ε of separator=[1−{(Wa/da+Wb/db+We/dc+ . . . +Wn/dn)/t}]×100 . . . Formula (4)

As the real density of the filler, employed was the density disclosed in product information on the filler used. As the real density of the resin, employed was the density disclosed in Non-Patent Literature 1 (Takashi Noma. “Aramidosenni no Tokutyou to Youto (Characteristics and Applications of Aramid)”, Special topic “Gouseisenni no Kaihatsu Doukou (Move in Development of Synthetic Fibers”). Senni to Kougyou (Fibers and Industries). p 242). As the real density of a polyolefin porous film which was made of polyethylene, employed was a density disclosed in product information on the film used.

### Open Area Ratio of Porous Layer

An SEM image was obtained by observing a surface of the porous layer with use of a scanning electron microscope (SEM, S-4800 (manufactured by Hitachi High-Technologies Corporation)). In this observation, the following were used: an acceleration voltage of 2 kV; a working distance (WD) of 5 mm; a secondary electron image; and an image resolution of 496 nm/pix. When the SEM image was obtained, image quality was adjusted with use of an autofocus function, an autocontrast function and the like. Software (3D-BON-FCS 2D particle analysis option) available from Ratoc System Engineering Co., Ltd. was used for the SEM image, and as a result of Auto LW, an image in which pores and a solid content part in the porous layer were shown in respective two tone levels was obtained. On the basis of the image thus obtained, the number of openings and the open area ratio of the surface of the porous layer were calculated.

### Withstand Voltage Property

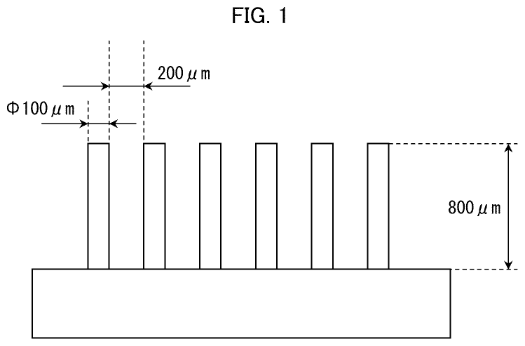

Onto the separator, placed was a cylindrical electrode probe of a withstand voltage tester (TOS9200, manufactured by KIKUSUI). The electrode probe had a diameter of 8 mm and had an uneven surface which had protrusions. The protrusions each had a diameter of 100 pm and a height of 800 μm and the distance between adjacent two of the protrusions was 200 μm as illustrated in FIG. 1. Next, a weight of 400 g was placed on the electrode probe. Thereafter, a voltage was applied at a voltage increase rate of 200 mV/sec, and a breakdown voltage of the separator was measured. The value of the breakdown voltage thus measured was considered as the value of the withstand voltage property of the separator.

Note that the withstand voltage test simulates an aspect in which voltage is applied while a load is being applied to a nonaqueous electrolyte secondary battery separator during actual charge and discharge of the nonaqueous electrolyte secondary battery. Thus, a high value of the withstand voltage property measured in the withstand voltage test indicates that the nonaqueous electrolyte secondary battery separator including the porous film has a favorable withstand voltage property during actual charge and discharge of the nonaqueous electrolyte secondary battery.

### Synthesis Example

As a vessel for synthesis, used was a separable flask which had a capacity of 3 L and which had a stirring blade, a thermometer, a nitrogen inlet pipe, and a powder addition port. Into the separable flask which had been sufficiently dried, 408.6 g of N-methyl-2-pyrrolidone (NMP) was introduced. Into this flask, 31.4 g of calcium chloride powder wad added, and the temperature was raised to 100° C., so that the calcium chloride powder was completely dissolved. This gave a solution 1. The calcium chloride powder had been vacuum-dried at 200° C. for two hours in advance.

Subsequently, the temperature (liquid temperature) of the solution 1 in the separable flask was cooled down to room temperature. Into the solution 1, 13.2 g of paraphenylenediamine was added and then completely dissolved. This gave a solution A. While the temperature (liquid temperature) of the solution A was kept at 20° C. ±2° C., 23.9 g of terephthalic acid dichloride was added, to the solution A, in three separate portions at approximately 10-minute intervals. This gave a solution B. After that, the solution B was aged for 1 hour while being stirred at 150 rpm and maintained at a temperature of 20° C.±2° C., so that an aramid polymerization solution 1 containing poly(paraphenylene terephthalamide) was obtained. A real density of the poly(paraphenylene terephthalamide) contained in the aramid polymerization solution 1 was set to be 1.44 g/cm² with reference to Non-Patent Literature 1.

### Example 1

Into a flask, 100 g of an aramid polymerization solution 1 was weighed out, and 6.0 g of Alumina C (manufactured by Nippon Aerosil Co., Ltd., average particle diameter: 0.013 μm, real density: 3.27 g/cm³) and 6.0 g of AKP-3000 (manufactured by Sumitomo Chemical Co., Ltd., average particle diameter: 0.7 μm, real density: 3.97 g/cm³) were added, so that a solution A was obtained. A weight ratio of poly(paraphenylene terephthalamide) and a total amount of alumina was 33:67. NMP was then added to the solution A so that a solid content could be 6.0% by weight. A resultant mixture was then stirred for 240 minutes, so that a solution B was obtained. Note that the “solid content” as used herein refers to a total weight of the poly(paraphenylene terephthalamide) and the alumina. To the solution B, 0.73 g of calcium carbonate was added and stirred for 240 minutes. As a result, the solution B was neutralized, so that a coating solution 1 in the form of slurry was prepared.

The coating solution 1 was left to stand for 8 minutes. The coating solution 1 was then applied, by a doctor blade method, onto a polyolefin porous film (thickness: 11.8 μm, air permeability: 159 sec/100 mL) that was made of polyethylene. A coated polyolefin porous film 1 thus obtained was immersed into ion exchange water, and the poly(paraphenylene terephthalamide) was deposited. Subsequently, the coated polyolefin porous film 1 was dried in an oven at a temperature of 70° C., so that a separator 1 was obtained. Table 1 shows physical properties of the separator 1.

### Example 2

A separator 2 was produced as in Example 1 except that liquid into which the coated polyolefin porous film was immersed was a liquid in which ion exchange water and NMP were at a weight ratio of 20:80. Table 1 shows physical properties of the separator 2.

### Example 3

A separator 3 was produced as in Example 1 except that liquid into which the coated polyolefin porous film was immersed was a liquid in which ion exchange water and NMP were mixed at a weight ratio of 30:70. Table 1 shows physical properties of the separator 3.

### Comparative Example 1

A separator 4 was produced as in Example 1 except that liquid into which the coated polyolefin porous film was immersed was a liquid in which ion exchange water and NMP were mixed at a weight ratio of 40:60. Table 1 shows physical properties of the separator 4.

### Comparative Example 2

The same operations as those in Example 1 were carried out except that liquid into which the coated polyolefin porous film was immersed was NMP. Unfortunately, poly(paraphenylene terephthalamide) was not deposited, so that a porous layer could not be obtained.

### Comparative Example 3

Poly(paraphenylene terephthalamide) was deposited by leaving the coated polyolefin porous film 1 to stand for one minute in the air at a temperature of 50° C. and at a relative humidity of 70%, and then the coated polyolefin porous film 1 was immersed into ion exchange water, so that calcium chloride and a solvent were removed. Except for these operations, a separator 5 was produced as in Example 1. Table 1 shows physical properties of the separator 5.

### Results

TABLE 1

| | Porous layer | | | | | | | | | |
|---|---|---|---|---|---|---|---|---|---|---|
| | production | | | | | | | | | |
| | condition | | | | | | | | | |
| | NMP | Separator | | | | Porous layer | | | | |
| | concentration | | | | Withstand | Weight | | | | Open |
| | in deposition | | Air | | voltage | per unit | Air | | Number | area |
| | solution | Thickness | permeability | Porosity | property | area | permeability | Porosity | of | ratio |
| | [%] | [μm] | [sec/100 mL] | [%] | [KV] | [g/m²] | [sec/100 mL] | [%] | openings | [%] |
| Ex. 1 | 0 | 15.5 | 249 | 47.4 | 2.00 | 2.5 | 90 | 65.0 | 23 | 0.01 |
| Ex. 2 | 20 | 15.7 | 245 | 48.0 | 1.91 | 2.6 | 86 | 66.0 | 42 | 0.02 |
| Ex. 3 | 30 | 15.6 | 254 | 47.2 | 1.95 | 2.6 | 95 | 65.0 | 32 | 0.01 |
| Comp. | 40 | 16.3 | 239 | 49.0 | 1.70 | 2.8 | 80 | 69.0 | 2533 | 2.65 |
| Ex. 1 | | | | | | | | | | |
| Comp. | 100 | —** | —** | —** | —** | —** | —** | —** | —** | —** |
| Ex. 2 | | | | | | | | | | |
| Comp. | Vapor* | 15.6 | 259 | 48.0 | 1.62 | 2.5 | 100 | 66.0 | 2980 | 9.91 |
| Ex. 3 | | | | | | | | | | |

Notes:
*The “vapor” in Table 1 means that the coated polyolefin porous film was exposed to the air at a temperature of 50° C. and at a relative humidity of 70%, that is, to vapor, and the resin was deposited, so that the porous layer was formed.
**The expression “—” in Table 1 means that measurement was impossible because the porous layer was not formed.
Abbreviations: “Example” is abbreviated as “Ex.”; and Comparative Example is abbreviated as “Comp. Ex.”

As shown in Table 1, each of the porous layers of the separators 1 to 3 had an air permeability of not more than 500 sec/100 mL and had an open area ratio of not more than 2%. As a result, each of the separators 1 to 3 had a withstand voltage property of not less than 1.9 kV. That is, each of the separators 1 to 3 had a favorable withstand voltage property.

In contrast, each of the porous layers of the separators 4 and 5 had an air permeability of not more than 500 sec/100 mL but had an open area ratio of more than 2%. Further, it was found that the each of the separators 4 and 6 had a withstand voltage property of less than 1.9 kV, that is, had an unfavorable withstand voltage property.

It has been clarified from the above that the separator in accordance with an embodiment of the present invention includes a porous layer having an air permeability of not more than 500 sec/100 mL and having an open area ratio of not more than 2% and this advantageously leads to an excellent withstand voltage property.

### INDUSTRIAL APPLICABILITY

A separator in accordance with an embodiment of the present invention can be used for production of a nonaqueous electrolyte secondary battery having an excellent withstand voltage property.

1. A nonaqueous electrolyte secondary battery separator comprising:
a porous film containing a polyolefin-based resin as a main component; and
a porous layer formed on one surface or both surfaces of the porous film,
the porous layer containing a resin,
the porous layer having an air permeability of not more than 500 sec/100 mL in terms of Gurley values, and
the porous layer having an open area ratio of not more than 2%,
where the open area ratio is calculated from a value that has been obtained by measuring a surface of the porous layer with use of a scanning electron microscope and binarizing a resultant image of the surface with use of image processing software.

2. The nonaqueous electrolyte secondary battery separator according to claim 1, wherein the porous layer has a porosity of not less than 40% and not more than 80%.

3. The nonaqueous electrolyte secondary battery separator according to claim 1, wherein the resin is at least one selected from the group consisting of a polyolefin, a (meth)acrylate-based resin, a fluorine-containing resin, a polyamide-based resin, a polyester-based resin, and a water-soluble polymer.

4. The nonaqueous electrolyte secondary battery separator according to claim 3, wherein the polyamide-based resin is an aramid resin.

5. A nonaqueous electrolyte secondary battery member comprising:
a positive electrode;
the nonaqueous electrolyte secondary battery separator according to claim 1; and
a negative electrode,
the positive electrode, the nonaqueous electrolyte secondary battery separator, and the negative electrode being disposed in this order.

6. A nonaqueous electrolyte secondary battery comprising the nonaqueous electrolyte secondary battery separator according to claim 1.
